(19) United States
(12) Patent Application Publication
(10) Pub. No.: US 2007/0202336 A1
(43) Pub. Date: Aug. 30, 2007

(54) Polymer blends containing glass material

(76) Inventor: Pearse O'Kane, Dublin (IE)

Correspondence Address: BIRCH STEWART KOLASCH & BIRCH, PO BOX 747, FALLS CHURCH, VA, 22040-0747, US

(21) Appl. No.: 11/654,694

(22) Filed: Jan. 18, 2007

Related U.S. Application Data
(63) Continuation of application No. 10/637,593, filed on Aug. 11, 2003, now abandoned.

(30) Foreign Application Priority Data
Feb. 9, 2001 (IE) S2001/0124

(51) Int. Cl. B32B 17/00; B29C 47/06; B29C 59/00

(52) U.S. Cl. 428/405; 264/211; 264/171.1; 264/173.11; 264/173.12; 264/129; 264/134

(57) ABSTRACT

A plastics material is prepared from a plastics material blend comprising PET or other plastics material in granular form, glass material in particle or fibre form and other processing aids. The scratch resistance of the plastics material prepared from the blend is significantly enhanced, and its temperature stability, impact resistance, fire resistance, ultraviolet stability and chemical inertness are also enhanced. Sheets of the plastics material with high scratch resistance are extruded and coextruded with unblended plastics materials which form a substrate or substrate core.

This application is a Continuation of copending application Ser. No. 10/637,593 filed on Aug. 11, 2003 which designated the United States, and on which priority is claimed under 35 U.S.C. § 120. This application also claims priority under 35 U.S.C. § 119(a) on Patent Application No(s). S2001/0124 filed in Ireland on Feb. 9, 2001. The entire contents of each of the above documents is hereby incorporated by reference.

### FIELD OF THE INVENTION

The present invention relates to a plastics material of relatively good scratch resistance and relatively high temperature stability and to a method for manufacturing such a plastics material.

### BACKGROUND OF THE INVENTION

Articles made from plastic materials, depending on the plastics material, may be in certain cases and for certain applications may have an acceptable scratch resistance and may have a certain combination of acceptable properties with regard to temperature stability, impact performance, fire rating, UV stability and chemical inertness. However, in general, the scratch resistance, temperature stability, impact performance, fire rating, UV stability and chemical inertness of articles made from plastic materials tend to be relatively poor. For example, many plastic materials in sheet form have relatively low scratch resistance and temperature stability. This is particularly so in the case of extruded sheet material of polyethylene terephthalate (PET). Typically, PET sheet materials tend to have relatively poor scratch resistance property and additionally PET sheet materials tend to become soft at temperatures at, or above, 65° C.

Attempts have been made heretofore to improve the scratch resistance and temperature stability of PET sheet material, and indeed, other articles of PET material, as well as sheet and articles of other plastics materials. However, such attempts, in general, have been unsuccessful. For example, articles of plastics materials have been coated to improve their scratch resistance, and in particular, articles of transparent plastics materials have been coated with a clear coating, normally an acrylic based coating, to improve their surface hardness, and thus, improve their scratch resistance. Such coated articles offer little improvement over the original product. In addition, the acrylic based or other coating may delaminate easily from the article. This is a particular problem where an article is to be formed from a sheet of plastics material which has been coated with an acrylic or other coating, since during thermoforming the acrylic or other coating readily delaminates from the substrate sheet.

A further problem associated with articles of PET material, and in particular PET sheet material, is that attempts to improve the temperature stability of PET sheet material result in a significant decrease in the impact resistant properties of the PET sheet. For example, the temperature stability of PET sheet material and other articles can be increased such that the PET material is temperature stable up to temperatures of approximately 150° C. However, in order to achieve these levels of temperature stability, it is necessary to increase the level of crystallinity within the molecular structure of the PET material, and this increased crystallinity level results in significant loss of impact resistant properties which thus results in the material becoming brittle.

Other plastics materials as well as PET material suffer from similar problems, for example, other polyesters, acrylics, polyethylenes, poly vinyl chlorides, polypropylenes, polycarbonates, acrylonitrile butadiene styrenes, polystyrenes and the like. Additionally, such problems are also associated with compounds and alloys of such plastics materials, and such problems can also be found in recycled plastics materials. Accordingly, in this specification the term “plastics materials” is intended to refer to the family of materials of each and every one of these plastics material, for example, the term “polyester materials” is to include all polyester, homo and copolymer materials and all alloys thereof, including polyethylene terephthalate, polytetramethylene terephthalate, polycyclohexane demethylene terephthalate, polycarbonates, etc.

It is also known to provide glass filled plastics as described for example in EP-A-0544147, U.S. Pat. No. 6,103,810, EP-A-1090946 and U.S. Pat. No. 5,104,924. However these glass filled plastics materials tend to be relatively rigid and brittle materials and are not suitable for many applications.

There is therefore a need for a method for manufacturing a plastics material which overcomes these problems. There is also a need for a plastics material which overcomes these problems, and there is a need for a plastics material article which overcomes these problems.

The present invention is directed towards providing such a method, a plastics material and a plastics material article.

### SUMMARY OF THE INVENTION

According to the invention there is provided a method for manufacturing a plastics material of a relatively good scratch resistance and relatively high temperature stability, said method including: forming an outer protective skin on a substrate of plastics material, said protective skin comprising a plastics material blend of plastics material and glass material.

In one embodiment the method includes co-extruding the substrate and the skin, covering at least a portion of the substrate with said skin.

In a preferred embodiment the method includes co-extruding the substrate and the skin in sheet form, and bonding the substrate sheet and skin sheet together.

In another embodiment the method includes co-extruding a substrate sheet and a single skin sheet, overlaying the single skin sheet and the substrate sheet, and bonding the single skin sheet and substrate sheet together. In a further embodiment the method includes: co-extruding a substrate sheet and a pair of skin sheets arranged on opposite sides of the substrate sheet, bonding the skin sheets to the opposite sides of the substrate sheet, the to substrate sheet being sandwiched between said skin sheets.

In another embodiment the method includes: co-extruding the substrate and the skin, fully covering an exterior of the substrate which forms a core within said skin.

In another embodiment the thickness of the protective skin is in the range 0.01 mm to 1.0 mm.

In a further embodiment the thickness of the substrate is in the range 1 mm to 50 mm.

In another embodiment the plastics material blend forming the skin has a glass content in the range 1.0% to 50% by weight.

In another embodiment the glass content is in the range 15% to 30% by weight of the plastics material blend.

In a further embodiment the plastics material blend forming the protective skin has a plastics content in the range 65% to 97%.

In a preferred embodiment the plastics material forming the substrate and the plastic material in the plastics material blend forming the protective skin are the same material.

In another embodiment the plastics material in the plastics material blend is Polyethylene Terephthalate material.

In another embodiment the plastics material in the plastics material blend is polycarbonate material.

In another embodiment the plastics material in the plastics material blend is polypropylene material.

In a further embodiment the plastics material of the plastics material blend is selected from any one or more of the following plastics materials; acrylic, polyethylene, poly vinyl chloride, acrylonitrile butadiene styrene, polystyrene and any compounds and/or alloys of such plastics materials, as well as homo and co-polymer materials and alloys and compounds thereof.

In another embodiment the plastics material forming the substrate and the plastics material in the plastics material blend forming the protective skin are different plastics material.

In another embodiment the plastics material blend includes glass material in the form of strands.

Conveniently the plastics material blend includes glass material in strand form of diameter in the range 10 to 50 microns, and of length in the range 100 microns to 1000 microns.

In another embodiment the plastics material blend includes glass material in the form of fibres.

In another embodiment the plastics material blend includes glass material in the form of beads.

In another embodiment the plastics material blend includes glass material in powder form.

In another embodiment the plastics material blend includes one or more additives selected from the following group: an impact modifier, a dispersing agent, an ultraviolet stabiliser, a flame retardant, a coloring agent.

In one embodiment of the invention the glass material is provided in the form of strands.

In another embodiment of the invention the glass material is provided in the form of fibres. Preferably, the maximum transverse cross-sectional dimension of the glass material is in the range of 8 microns to 20 microns. Advantageously, the maximum transverse cross-sectional dimension of the glass material is in the range of 9 microns to 11 microns. Preferably, the glass material is in elongated form of continuous length.

Advantageously, the glass material is of length in the range of 50 microns to 1,000 microns. Preferably, the glass material is of length in the range of 200 microns to 500 microns. Ideally, the glass material is of length greater than 150 microns and typically, the glass material is of length of 350 microns approximately.

Alternatively, the glass material is in the form of beads. Preferably, the maximum dimension of the glass material is in the range of 1 micron to 20 microns. Advantageously, the maximum dimension of the glass material is in the range of 8 microns to 10 microns.

In a further alternative embodiment of the invention the glass material is in powder form. Preferably, the glass material is of particle size not greater than 1 micron.

Ideally, the plastics material blend comprises the glass material to an effective amount for providing relatively good scratch resistance.

Preferably, the plastics material blend comprises the glass material to an effective amount for providing relatively good temperature stability.

In one embodiment of the invention the plastics material blend comprises the glass material to an effective amount for providing relatively good impact resistance.

In another embodiment of the invention the plastics material blend comprises the glass material to an effective amount for providing relatively good fire resistance.

In a further embodiment of the invention the plastics material blend comprises the glass material to an effective amount for providing relatively good ultraviolet stability.

In a still further embodiment of the invention the plastics material blend comprises the glass material to an effective amount for providing relatively good chemical inertness.

In one embodiment of the invention the glass material constitutes in the range of 10% wt. to 50% wt. of the plastics material blend. Preferably, the glass material constitutes in the range of 20% wt. to 40% wt. of the plastics material blend. Ideally, the glass material constitutes approximately 30% wt. of the plastics material blend.

In one embodiment of the invention the plastics material blend comprises an impact modifier. Preferably, the impact modifier is in particulate form. Advantageously, the impact modifier is in an effective amount for providing relatively good impact resistance. Preferably, the impact modifier constitutes in the range of 5% wt. to 25% wt. of the plastics material blend. Advantageously, the impact modifier constitutes in the range of 5% wt. to 15% wt. of the plastics material blend. Preferably, the impact modifier constitutes in the range of 5% wt. to 10% wt. of the plastics material blend.

The impact modifier is selected to be compatible with the plastics material of the plastics material blend, in one embodiment of the invention the plastics material of the plastics material blend is PET material, and the impact modifier is selected from any one or more of the following impact modifiers: a terpolymer containing ethylene and acrylates, a polyolefin terpolymer elastomer, a polycarbonate/polyester blend, a polycarbonate/ABS blend to a polycarbonate alloy.

In one embodiment of the invention the plastics material blend comprises a dispersing agent for dispersing the glass material. Preferably, the dispersing agent is in particulate form. Advantageously, the dispersing agent constitutes in the range of 0.01% wt. to 10% wt. of the plastics material blend. Advantageously, the dispersing agent constitutes in the range of 0.05% wt. to 1% wt. of the plastics material blend. Ideally, the dispersing agent constitutes approximately 0.1% wt. of the plastics material blend.

In one embodiment of the invention the plastics material blend comprises a processing aid for integration of the glass material. Preferably, the processing aid is in particulate form. Advantageously, the processing aid constitutes in the range of 0.01% wt. to 10% wt. of the plastics material blend. Preferably, the processing aid constitutes in the range of 0.05% wt. to 1% wt. of the plastics material blend. Ideally, the processing aid constitutes approximately 0.1% wt. of the plastics material blend.

In another embodiment of the invention the plastics material blend comprises a coupling agent for integration of the glass material. Preferably, the coupling agent is in particulate form. Advantageously, the coupling agent constitutes in the range of 0.01% wt. to 10% wt. of the plastics material blend. Preferably, the coupling agent constitutes in the range of 0.05% wt. to 1% wt. of the plastics material blend. Advantageously, the coupling agent constitutes approximately 0.1% wt. of the plastics material blend.

In another embodiment of the invention the plastics material blend comprises an ultraviolet stabiliser for improving stability of the plastics material in ultraviolet light.

Preferably, the ultraviolet stabiliser is in particulate form. Advantageously, the ultraviolet stabiliser constitutes in the range of 1% wt. to 10% wt. of the plastics material blend. Ideally, the ultraviolet stabiliser constitutes approximately 4% wt.

In a further embodiment of the invention the plastics material blend comprises a flame retardant additive. Preferably, the flame retardant additive is in particulate form. Advantageously, the flame retardant additive constitutes in the range of 1 wt. to 10% wt. of the plastics material blend. Ideally, the flame retardant additive constitutes approximately 3% wt. of the plastics material blend.

In another embodiment of the invention the plastics material is formed by extruding the plastics material blend in the viscous flowable state.

In a further embodiment of the invention the plastics material blend is co-extruded with a substrate material.

In one embodiment of the invention the plastics material blend forms an outer skin on the substrate.

In another embodiment of the invention the outer skin covers at least one major surface of the substrate.

In a further embodiment of the invention the outer skin covers both major surfaces of the substrate.

In a still further embodiment of the invention the substrate forms a core, and the outer skin extends around the core.

In one embodiment of the invention the substrate material is of a material the same or different to the plastics material blend.

In another embodiment of the invention the substrate material is an unblended plastics material.

In a further embodiment of the invention the plastics material of the substrate is similar to the plastics material of the plastics material blend.

In one embodiment of the invention the plastics material of the substrate is selected from any one or more of the following plastics materials: polyethylene terephthalate, acrylics, polyethylenes, poly vinyl chlorides, polypropylenes, polycarbonates, acrylonitrile, butadiene styrenes, polystyrenes and other polyester materials.

In another embodiment of the invention the substrate is extruded to form a sheet.

In a still further embodiment of the invention the plastics material blend is extruded in sheet form.

In one embodiment of the invention the plastics material blend is dried to an appropriate moisture content prior to being heated to the viscous flowable state. Advantageously, the plastics material blend is dried to a moisture content in the range of 20 ppm to 40 ppm. Preferably, the plastics material blend is dried to a moisture content of approximately 30 ppm. Ideally, the plastics material blend is dried for a time period in the range of two hours to six hours at a temperature in the range of 140° C. to 170° C.

In one embodiment of the invention the plastics material blend is dried in a dehumidifying desiccant dryer for a time period in the range of two hours to three hours.

In another embodiment of the invention the plastics material blend is heated to a temperature in the range of 200° C. to 325° C. for causing the plastics material blend to become viscous and flowable.

In a further embodiment of the invention the plastics material blend is heated to a temperature in the range of 265° C. to 300° C. for causing the plastics material blend to become viscous and flowable.

In one embodiment of the invention the plastics material of the plastics material blend is selected from any one or more of the following plastics materials: polyethylene terephthalate, acrylics, polyethylenes, poly vinyl chlorides, polypropylenes polycarbonates, acrylonitrile butadiene, styrenes, polystyrenes and other polyester materials and any compounds and/or alloys of such plastics materials, as well as homo and co-polymer materials and alloys and compounds thereof.

In another embodiment of the invention the plastics material of the plastics material blend is of particle size in the range of 2,000 microns to 4,000 microns.

In another embodiment of the invention the plastics material of the plastics material blend is a transparent plastics material.

In a further embodiment of the invention the glass material is transparent material.

In one embodiment of the invention the glass material is selected so that the formed plastics material from the plastics material blend is transparent.

In another embodiment of the invention the refractive index of the glass material is matched with the refractive index of the plastics material of the plastics material blend.

In another embodiment of the invention the plastics material blend comprises a polyester crystalliser inhibitor for controlling the rate and level of crystallisation of the plastics material blend during curing after the plastics material blend has been formed for maintaining transparency of the formed plastics material.

In a further embodiment of the invention the plastics material blend comprises an antioxidant for reducing degradation of the formed plastics material formed from the plastics material blend.

In a still further embodiment of the invention the plastics material of the plastics material blend is recycled plastics material.

In another embodiment of the invention the substrate is of recycled plastics material.

In one embodiment of the invention a plastics material article is formed from the plastics material blend by injection moulding.

In another embodiment of the invention a plastics material article is formed from the plastics material blend by rotational moulding.

In a further embodiment of the invention a plastics material article is formed from the plastics material blend by blow moulding.

In a still further embodiment of the invention an article is thermoformed from the plastics material of the invention.

Additionally the invention provides a plastics material manufactured according to the method of the invention.

Further the invention provides plastics material comprising a substrate of plastics material at least partially covered by an outer protective skin comprising a plastics material blend of plastics material and glass material.

Additionally the invention provides an article of plastics material manufactured from a plastics material prepared according to the method of the invention.

The invention also provides an article manufactured from the plastics material according to the invention.

Further the invention provides an article of plastics material, the article being manufactured from a plastics material blend wherein the plastics material blend comprises plastics material in particulate form and glass material, which after being blended is heated to a viscous flowable state from which the article is formed.

In one embodiment of the invention the article is in the form of a sheet.

In another embodiment of the invention the sheet formed from the plastics material blend is subsequently laminated to a substrate.

In a further embodiment of the invention the article comprises a substrate and a sheet formed from the plastics material blend laminated with the substrate.

In a still further embodiment of the invention the substrate is of a plastics material.

In one embodiment of the invention the plastics material is formed by extruding the material in the viscous flowable state.

In another embodiment of the invention the plastics material is co-extruded with a substrate material.

In a further embodiment of the invention the plastics material blend forms an outer skin of the substrate.

In another embodiment of the invention the outer skin covers at least one major surface of the substrate.

In a further embodiment of the invention the outer skin covers both major surfaces of the substrate.

In a still further embodiment of the invention the substrate material forms a core, and the outer skin extends around the core.

In another embodiment of the invention the substrate material is of a material the same or different to the plastics material blend.

In one embodiment of the invention the substrate material is an unblended plastics material.

In another embodiment of the invention the plastics material of the substrate is similar to the plastics material of the plastics material blend.

In one embodiment of the invention the article is formed from the plastics material blend by injection moulding.

In another embodiment of the invention the article is formed from the plastics material blend by rotational moulding.

In a further embodiment of the invention the article is formed from the plastics material blend by blow moulding.

In a further embodiment of the invention the formed plastics material from the plastics material blend forms a protective coating on a substrate.

The invention also provides a plastics material blend comprising a plastics material in particulate form and glass material blended with the plastics material.

Additionally the invention provides a sheet of plastics material formed from the plastics material formed by the method according to the invention characterised in that the sheet of plastics material is suitable for thermoforming.

Additionally the invention provides a thermoformed article formed from the sheet of plastics material according to the invention.

### BRIEF DESCRIPTION OF THE DRAWINGS

The invention will be more clearly understood from the following description of the following non-limiting examples, which are given with reference to the accompanying drawings, in which:

FIG. 1 is a transverse cross-sectional end view of an extruded sheet of plastics material not to scale according to the invention,

FIG. 2 is a transverse cross-sectional end view of an extruded sheet of plastics material not to scale also according to the invention,

FIG. 3 is a diagrammatic elevational view of a temperature stability test cabinet in which temperature stability tests on the extruded sheets according to the invention are carried out, and

FIG. 4 is a diagrammatic elevational view of a test rig in which impact tests are carried out on the extruded sheets according to the invention.

### DETAILED DESCRIPTION OF THE INVENTION

In each of the following examples respective plastics material blends according to the invention are prepared. In Examples 1 to 6 the plastics material of the plastics material blends is polyethylene terephthalate (PET) material in particle form of particle size in the range of 2,000 microns to 4,000 microns. In Examples 7 to 9 the plastics material of the plastics material blends is polycarbonate material in particle form of particle size in the range of 2,000 microns to 4,000 microns. In Examples 1 to 6 the plastics materials blends each comprise an impact modifier, namely, terpolymer sold by BASF under the Trade Mark ULTRADUR, which may be in powder or particulate form. As well as acting as an impact modifier the polyolefin terpolymer elastomer also acts as a processing aid.

In Examples 7 to 9 each plastics material blend comprises a dispersing agent and a coupling agent for facilitating dispersal of the constituents of the plastics material blends throughout the plastics material blends. In Examples 1 to 9 the plastics material blends each comprise glass material, which is in strand form of diameter of approximately 10 microns to 13 microns, and of length ranging from 200 microns to 500 microns. Additionally, each of the plastics material blends of Examples 1 to 9 comprise an ultraviolet stabiliser which in each case is an ultraviolet stabiliser sold by CIBA under the Trade Mark TINUVIN, which may be in powder or particulate form. The plastics material blends of Examples 3 to 5 each comprise a fire retardant additive, which is provided by Zinc Stannate and PTFE sold by BIP, which may be in powder or particulate form. The plastics material blends of Examples 6 and 9 each comprise a color pigment which may be any suitable pigment, depending on the color desired.

In each of the Examples 1 to 9 the constituents of the plastics material blends are thoroughly mixed and blended together. The plastics material blends are dried in a dehumidifying desiccant dryer to a moisture content of not more than 40 ppm. The plastics material blends of Examples 1 to 6 are dried at a temperature of approximately 170° C. for a time period of approximately four hours. The plastics to material blends of Examples 7 to 9 are dried at a temperature of approximately 120° C. for a time period of approximately three hours.

In each of the Examples 1 to 9 a plastics material sheet is extruded from the plastics material blends as will be described in more detail in each example. The dried plastics material blends are placed in an auger extruder where they are heated to a temperature in the range of 280° C. to 320° C., depending on plastics material of the plastics material blend in order that the plastics material blends become viscous and flowable, and are extruded to form the sheet of plastics material.

### EXAMPLE 1

In this example the plastics material blend comprises the PET material, the glass material, the impact modifier and the UV stabiliser in the following proportions:

After blending and drying, the plastics material blend is placed in an extruder and heated to a viscous flowable state and is co-extruded from the extruder with extruded unblended PET material to form a sheet whereby the unblended PET material forms a substrate core with the plastics material blend forming an outer skin completely surrounding the core when viewed in transverse cross-section. Co-extrusion of plastics material will be well known to those skilled in the art. The extruded sheet may be of any width and any thickness, however, in this embodiment of the invention sheets of two sizes are extruded. In

| | | |
|---|---|---|
| Glass material | 21.0% | wt. |
| Impact modifier | 7.0% | wt. |
| UV stabiliser | 4.0% | wt. |
| PET material | 68.0% | wt. |

one of the sheets the substrate core of the unblended PET material is of width 1,500 mm and thickness of approximately 4.5 mm. The co-extruded outer skin of blended PET material is approximately 0.4 mm thick. In the other sheet the substrate core is of width 870 mm and thickness of approximately 2.0 mm. The co-extruded outer skin of the blended PET material is 0.05 mm thick. thickness of approximately 2.0 mm. The co-extruded outer skin of the blended PET material is 0.05 mm thick.

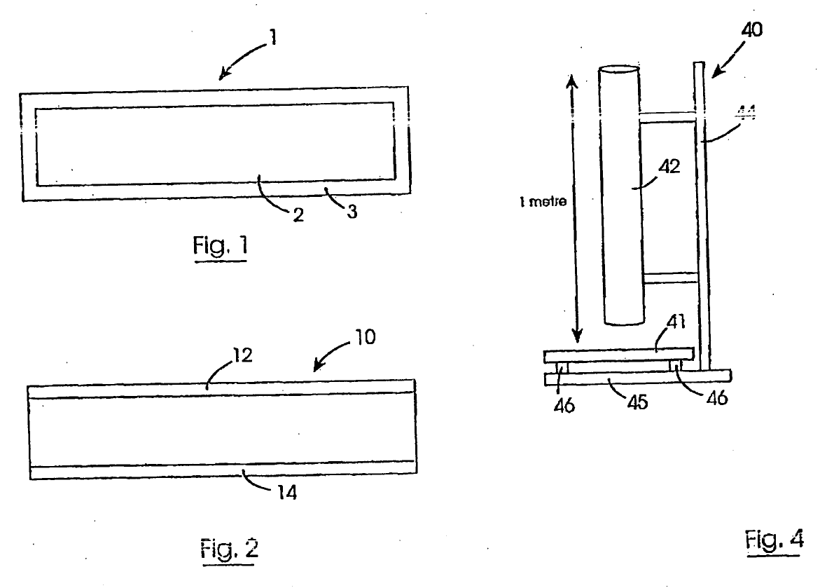

Referring now to FIG. 1, a typical co-extruded sheet according to the invention manufactured according to Example 1 is illustrated in FIG. 1 and is indicated generally by the reference numeral 1. The sheet 1 comprises the substrate core 2 which is surrounded by the outer skin 3 of the plastics material blend which is coextruded with the unblended plastics material of the core 2.

### EXAMPLE 2

| | | |
|---|---|---|
| Glass material | 1.5% | wt. |
| Impact modifier | 0.5% | wt. |
| UV stabiliser | 0.5% | wt. |
| Fire retardant additive | 0.5% | wt. |
| PET material | 97% | wt. |

In this example the plastics material blend comprises the PET material, the glass material, the impact modifier and the UV stabiliser in the following proportions: After blending and drying the plastics material blend is placed in an extruder, and is heated to a viscous and flowable state. The plastics material blend is co-extruded with unblended PET material which forms a substrate with which the plastics material blend is co-extruded. In this example the plastics material blend is coextruded with the unblended PET material such that the unblended PET material forms a substrate and the blended PET material forms a top outer skin and a bottom outer skin extending over the opposite major surfaces of the substrate. Sheets of two sizes are extruded. In one of the sheets the width of the extruded sheet is 1,500 mm and the thickness of the substrate is 4.5 mm. The thickness of the top and bottom outer skins of the blended PET material is approximately 0.4 mm thick. In the other sheet the width of the extruded sheet is 870 mm, and the thickness of the substrate is 3.0 mm. The thickness of the top and bottom outer skins is similar to the other sheet.

Referring now to FIG. 2, there is illustrated a co-extruded sheet also according to the invention manufactured according to Example 2 which is indicated generally by the reference numeral 10. The co-extruded sheet 10 comprises the substrate 11 with which top and bottom outer skins 12 and 14 of the plastics material blend are co-extruded.

### EXAMPLE 3

In this example the PET material blend comprises the PET material, the glass material, the impact modifier, the UV stabiliser and the fire retardant additive in the following proportions: After the plastics material blend has been blended and dried, the plastics material blend is placed in an extruder and heated to become viscous and flowable, the plastics material blend is extruded to form sheets of width of approximately 1,500 mm and 870 mm and thickness of approximately 4.5 mm and 3.0 mm, respectively. In this example the plastics material blend forms the entire sheets, and the sheets do not include a substrate material.

### EXAMPLE 4

In this example the plastics material blend comprises the PET material, the glass material, the impact modifier, the UV stabiliser and the fire retardant additive in the following proportions:

| | | |
|---|---|---|
| Glass Material | 3.0% | wt |
| Impact modifier | 4.0% | wt |
| UV stabilizer | 0.5% | wt |
| Fire retardant addictive | 0.5% | wt |
| PET material | 95.0% | wt |

After blending and drying, the plastics material blend is placed in an extruder and heated to become viscous and flowable, the plastics material blend is extruded to form sheets of two different sizes, namely, widths of approximately 1,500 mm and 870 mm and thicknesses of approximately 4.5 mm and 3.0 mm, respectively. The sheet of plastics material blend in this example do not comprise a substrate.

### EXAMPLE 5

In this example two plastics material blends are prepared for forming a substrate core of an extruded sheet, and a co-extruded outer skin. The two plastics material blends comprise the PET material, the glass material, the impact modifier, the UV stabiliser and the fire retardant additive in the following proportions for the outer skin and the substrate core:

| | |
|---|---|
| (A) outer skin | (b) Substrate core |

| | | | | |
|---|---|---|---|---|
| Glass Material | 15.0% | wt | 1.5% | wt |
| Glass material | 15.0% | wt. | | |
| Impact modifier | 5.0% | wt. | | |
| UV stabiliser | 4.0% | wt. | | |
| Color | 3.0% | wt. | | |
| PET material | 73.0% | wt. | | |
| Impact modifier | 5.0% | wt | 0.5% | wt |
| UV stabilizer | 4.0% | wt | 0.5% | wt |
| Fire retardant addictive | 3.0% | wt | 0.5% | wt |
| PET material | 73.0% | wt | 97.0% | wt |

After the two plastics material blends have been blended and dried they are appropriately placed in an extruder where they are heated to become viscous and flowable.

The two plastics material blends are co-extruded so that the plastics material blend B forms the substrate core and the plastics material blend A forms an outer skin extending completely around the substrate core when viewed in transverse cross-section. Sheets of two sizes are extruded. The substrate of one sheet is of width 1,500 mm, and is of thickness of approximately 4.5 mm, and the substrate of the other sheet is of width of 870 mm and of thickness of approximately 3.0 mm. The outer skin of both sheets is approximately 0.4 mm thick.

### EXAMPLE 6

In this example the plastics material blend comprises the PET material, the glass material, the impact modifier, the UV stabiliser and the color pigment in the following proportions: After the plastics material blend is blended and dried, the plastics material blend is placed in an extruder and heated to become viscous and flowable, and is then coextruded with unblended PET material such that the unblended PET material forms a substrate with the plastics material blend co-extruded to form an outer skin extending over a top major surface of the substrate sheet only. Sheets of two sizes are extruded. The substrate of unblended PET material of one sheet is of width 1,500 mm and thickness of approximately 4.5 mm, and the substrate of the other sheet is of width approximately 870 mm and of thickness approximately 3.0 mm. The co-extruded outer skin of the plastics material blend of both sheets is approximately 0.5 mm thick.

### EXAMPLE 7

In this example the plastics material blend comprises the polycarbonate material, the glass material, the UV stabiliser and the dispersing agent in the following proportions: Glass material 30.0% wt. UV stabilizer 4.0% wt. Dispersing agent 0.1% wt. PC material 65.9% wt.

After the plastics material blend has been blended and dried, it is placed in an extruder where it is heated to the temperature to become viscous and flowable and is co-extruded with unblended polycarbonate material to form a sheet in which the unblended polycarbonate material forms a substrate core with the plastics material blend extending completely around the substrate core to form an outer skin when viewed in transverse cross-section. The substrate core of the sheet is of width 870 mm and thickness of approximately 3 mm. The outer skin formed by the plastics material blend is of thickness of approximately 0.3 mm.

### EXAMPLE 8

In this example the plastics material blend comprises the polycarbonate material, the glass material, the UV stabiliser and the dispersing agent in the following proportions;

| | | |
|---|---|---|
| Glass material | 20.0% | wt. |
| UV stabiliser | 4.0% | wt. |
| Dispensing agent | 0.1% | wt. |
| PC material | 75.9% | wt. |

After blending and drying of the plastics material blend, the plastics material blend is placed in an extruder where it is heated to become viscous and flowable, and is coextruded to form a sheet with unblended polycarbonate material which forms a substrate of the sheet. The blended plastics material is co-extruded over the top and bottom major surfaces of the substrate to form respective top and bottom outer skins. The substrate is of width of 870 mm and thickness of approximately 3 mm. The co-extruded top and bottom outer skins of the blended plastics material are approximately 0.3 mm thick each.

### EXAMPLE 9

In this example the plastics material blend comprises the polycarbonate material, the glass material, the UV stabiliser, the dispersing agent and the color pigment in the following proportions:

| | | |
|---|---|---|
| Glass material | 15.0% | wt. |
| UV stabiliser | 4.0% | wt. |
| Dispersing agent | 0.1% | wt. |
| Color | 3.0% | wt. |
| PC material | 77.9% | wt. |

After blending and drying, the plastics material blend is placed in an extruder where it is heated to become viscous and flowable and is co-extruded with unblended polycarbonate material to form a sheet, the unblended polycarbonate material forming a substrate with which the plastics material blend is co-extruded to form top and bottom outer skins extending over the opposite major surfaces of the substrate. The substrate is of width of approximately 870 mm and thickness of approximately 3 mm. The co-extruded top and bottom outer skins of the plastics material blend are of approximately 0.3 mm thick each.

### EXAMPLE 10

In this example the plastics material blend comprises polypropylene material (PP), the glass material, the dispersing agent and the color pigment in the following proportions:

| | | |
|---|---|---|
| Glass material | 30.0% | wt |
| Dispensing agent | 0.1% | wt |
| Color | 3.0% | wt |
| PP material | 66.9% | wt |

The plastics material blend is placed in an extruder where it is heated to become viscous and flowable and is co-extruded with unblended polypropylene material to form a sheet, the unblended polyproylene material forming a substrate with which the plastics material blend is co-extruded to form top and bottom outer skins extending over the opposite major surfaces of the substrate. The substrate is of width of approximately 1200 mm and thickness of approximately 4 mm. The co-extruded top and bottom outer skins of the plastics material blend are of approximately 0.25 mm thick each.

Extruded sheets of Example 10 have been thermoformed into industrial components, for example, both light and heavy industrial parts, including panels for earth moving equipment and in all cases the thermoformed components have been found to exhibit higher scratch resistance and temperature stability properties, as well as improved impact resistance, fire resistance and UV stability, as well as chemical inertness properties, than would otherwise be expected.

Tests and Results

The extruded sheets of Examples 1 to 9 were tested for scratch resistance, temperature stability, impact resistance, fire rating, UV stability and chemical inertness in accordance with the standard test procedures set forth in ISO and ASTM Standards.

Additionally, comparative tests were carried out with a conventional extruded sheet of PET material and a conventionally extruded sheet of polycarbonate material. The conventionally extruded sheets were selected so that the PET material and polycarbonate material of the conventionally extruded sheets were of similar grade to those of the sheets extruded in Examples 1 to 6, and Examples 7 to 9, respectively. The conventional sheet of PET material on which the comparative tests were carried out was a sheet sold by Du Pont under the Trade Mark LASER PLUS, and the conventional sheet of polycarbonate material on which the comparative tests were carried out was a sheet sold by Bayer under the Trade Mark MAKROLON 3103. The dimensions of the conventional sheets were as follows: Conventional PET Sheet Width 870 mm, thickness 3 mm Conventional Polycarbonate Sheet Width 870 mm, thickness 3 mm.

In order that the sheets of the Examples 1 to 9 and the conventional sheets were of similar size, the extruded sheets of Examples 1 to 9 of width 870 mm were selected for the tests.

The results of the tests are set forth in Table 1. It can be seen that the extruded sheets of Examples 1 to 9 exhibit properties which are significantly better than the corresponding properties of the conventional comparative sheets. The extruded sheets according to Examples 1 to 9 exhibit significantly improved scratch resistant properties, are more temperature stable, have higher impact resistance and are more fire resistant. UV stability and chemical inertness is also found to be improved in the extruded sheets of Examples 1 to 9 over and above those of the two comparative sheets.

TABLE 1

| | Scratch | Temp | | Impact | Fire | UV | Chem |
|---|---|---|---|---|---|---|---|
| Conventional | 2H | 65° | C. | 1 Kg | V2 | Good | Good |
| PET sheet | | | | | | | |
| 1 | 9H | 80° | C. | 5 Kg | VO | Imprvd | Imprvd |
| 2 | 9H | 75° | C. | 4 Kg | VO | Imprvd | Imprvd |
| 3 | 6H | 70° | C. | 2 Kg | VO | Imprvd | Imprvd |
| 4 | 6H | 72° | C. | 3 Kg | VO | Imprvd | Imprvd |
| 5 | 9H | 75° | C. | 4 Kg | VO | Imprvd | Imprvd |
| 6 | 9H | 80° | C. | 5 Kg | VO | Imprvd | Imprvd |
| Conventional | 2H | 135° | C. | 2 Kg | V2 | Avg | Poor |
| PC* sheet | | | | | | | |
| 7 | 9H | 145° | C. | 3 Kg | VO | Imprvd | Imprvd |
| 8 | 9H | 145° | C. | 3 Kg | VO | Imprvd | Imprvd |
| 9 | 9h | 145° | C. | 3 Kg | VO | Imprvd | Imprvd |

*polycarbonate

The test used to determine scratch resistance was the simple but effective standard “H” pencil test. This test requires drawing pencils of lead of varying degrees of hardness from H, 2H, and upwards across the surface or surfaces of the sheet, and determining the lowest grade of hardness of pencil lead which marks the sheet, in other words, leaves a scratch, or indent in the surface of the sheet. The conventional PET and polycarbonate sheets were unaffected by pencils of 2H lead but showed scratching when subjected to pencils of 3H lead. The extruded sheets of Examples 1, 2 and 5 to 9, inclusive were unaffected by pencils of leads up to 9H.

The extruded sheets of Examples 3 and 4 were unaffected by pencils of lead up to 6H, but showed marginal scratching when subjected to pencils of lead of 7H. The conventional PET sheet became temperature unstable at approximately 65° C., while the extruded sheets of Examples 1 to 6 remained stable up to higher temperatures, and in some cases significantly higher temperatures. For example, the extruded sheets of Examples 1 and 6 only became temperature unstable at approximately 80° C., while those of Examples 2 and 3 only became temperature unstable at approximately 75° C. The temperature stability of the extruded sheets of Examples 3 and 4 were slightly lower, in that the sheet of Example 4 became temperature unstable at approximately 72° C., while that of Example 3 which demonstrated the lowest temperature stability became temperature unstable at 70° C.

The conventional polycarbonate sheet became temperature unstable at approximately 135° C., while the extruded sheets of Examples 7 to 9 each only became temperature unstable when the temperature reached approximately 145° C.

Additionally, all the extruded sheets of Examples 1 to 9 demonstrated higher impact resistance to those of the conventional PET and polycarbonate sheets. The impact resistance of the conventional PET and polycarbonate sheets were respectively 1 kg and 2 kg. The extruded sheets of Examples 1 to 6 each demonstrated an impact resistance of 5 kg, while those of Examples 2 and 5 demonstrated impact resistance of 4 kg. The impact resistance of the extruded sheets of Examples 3 and 4 were 2 kg and 3 kg, respectively. Each of the extruded sheets of Examples 7 to 9 demonstrated impact resistance of 3 kg as opposed to 2 kg for the conventional polycarbonate sheet.

The fire resistance of the respective extruded sheets of Examples 1 to 9 was also improved over and above that of the conventional PET and polycarbonate sheets, each of which had a fire rating of V2. Each of the extruded sheets of Examples 1 to 9 demonstrated a fire rating of VO as determined by UL 94, which is a significant improvement on that of the corresponding conventional sheets.

All the extruded sheets of Examples 1 to 9 demonstrated improved UV stability and chemical inertness over and above the corresponding conventional PET and polycarbonate sheets.

Accordingly, from the results of the tests carried out on the extruded sheets of Examples 1 to 9, it is clear that the inclusion of glass material in the plastics material blends contributes significantly to enhancing the overall properties of the plastics material sheets extruded from the plastics material blends. It has been found that blending glass material with a plastics material, and then co-extruding the plastics material blend with a substrate or core of unblended plastics material, which may be the same or different to the plastics material of the plastics material blend, substantially increases the scratch resistance of the plastics material, and it has also been found that blending glass material with a plastics material increases the modulus of sheets or articles formed from the plastics material blend. It has also been found that the glass material forms a random matrix with increased modulus in the plastics material blend which protects and supports the substrate material. This matrix contributes to increasing the temperature stability of the plastics material, while also increasing the impact resistance, fire rating, UV stability and chemical inertness of the composite plastics material.

Additionally, it has been found that the outer skins of the co-extruded sheets of Examples 1, 2, 5 and 6 are more crystalline than the substrate sheet, which contributes to the increase in temperature stability of the co-extruded sheet.

The extruded sheets of Examples 1 to 9 have all been thermoformed into industrial components, for example, roof domes, domestic water storage tanks, corrugated roofing, and both light and heavy industrial parts, and in all cases the thermoformed components have been found to exhibit higher scratch resistance and temperature stability properties, as well as improved impact resistance, fire resistance and UV stability, as well as chemical inertness properties, than would otherwise be expected.

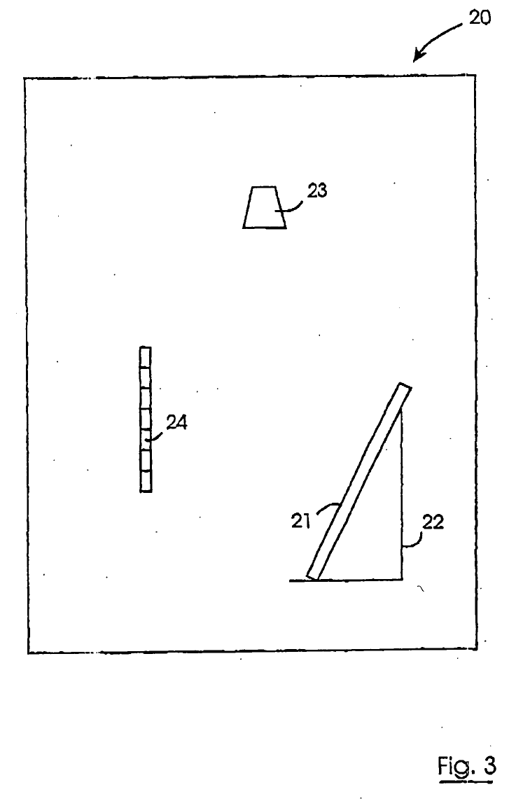

Referring now to FIG. 3, the temperature stability tests on the extruded sheets of Examples 1 to 9 and on the conventional PET and polycarbonate sheets were carried out in an insulated cabinet indicated generally by the reference numeral 20. Test samples 21 of size 870 mm×580 mm were supported on a support bracket 22 in the insulated cabinet 20. The test samples 21 were supported on the support bracket 22 at an angle of inclination to the horizontal of approximately 60°. An overhead infrared heat source 23 directed infrared radiant heat at the test sample 21, and a temperature sensor 24 located within the insulated cabinet monitored the temperature of the test sample. Each test sample was deemed to have become temperature unstable when it began to soften visibly.

Referring now to FIG. 4, the impact tests of the extruded sheets of Examples 1 to 9 and the conventional PET and polycarbonate sheets were carried out using a test rig of the type illustrated in FIG. 4 and indicated generally by the reference numeral 40. A dart (not shown) having a rounded tip was dropped from a height of 1 metre above a test sample 41 through a guide tube 42 and the force of the impact was measured to determine the impact resistance of the test sample to the dart. The guide tube 42 is supported on a support structure 44 which extends upwardly from a base 45 on which the test sample is supported on a pair of parallel spaced apart elongated supports 46 which are spaced at a distance of 200 mm. Each test sample was of size 295 mm×210 mm.

It will be appreciated that the invention provides a plastics material having a concentration of glass material adjacent a surface of the plastics material giving improved scratch resistance and temperature stability. The outer protective skin incorporating the glass material is fused with an essentially integral with the substrate. Examples have been described as being of PET, polycarbonate and polypropylene material, it will be readily apparent to those skilled in the art that the method may be used in connection with any of the plastics materials discussed in the introduction to the specification, and indeed, the plastics materials and plastics material articles may be of any suitable plastics materials such as the plastics materials discussed in the introduction to the specification.

While the plastics materials articles have been described as being extruded sheets, it is envisaged that any other type of plastics material article may be manufactured. It is also envisaged that the plastics materials articles may be manufactured by methods other than extrusion, for example, injection moulding, rotational moulding, blow moulding, and any other suitable plastics forming processes.

It is also envisaged that where the articles according to the invention are formed from the plastics material blend by injection moulding, it is envisaged that they may be insert injection moulded, where central cores of unblended plastics material would be centrally located in the mould, and the plastics material blend would form an outer skin around the central core.

Additionally, as well as the two extruded sheets described as having been extruded from the PET material blend of Example 1, a sheet of a third size was also extruded which had a substrate core of width 870 mm and thickness 3.0 mm. The co-extruded outer skin of the blended PET material was approximately 0.35 mm thick.

The invention is not limited to the embodiments hereinbefore described which may be varied in construction and detail within the scope of the appended claims.

What is claimed is:

1. A method for manufacturing a plastics material of a relatively good scratch resistance and relatively high temperature stability, said method including:
forming an outer protective skin on a substrate of plastics material,
said protective skin comprising a plastics material blend of plastics material and glass material.

2. A method as claimed in claim 1 including co-extruding the substrate and the skin, covering at least a portion of the substrate with said skin.

3. A method as claimed in claim 1, including co-extruding the substrate and the skin in sheet form, and bonding the substrate sheet and skin sheet together.

4. A method as claimed in claim 3, including co-extruding a substrate sheet and a single skin sheet,
overlaying the single skin sheet and the substrate sheet, and
bonding the single skin sheet and substrate sheet together.

5. A method as claimed in claim 3, including:
co-extruding a substrate sheet and a pair of skin sheets arranged on opposite sides of the substrate sheet,
bonding the skin sheets to the opposite sides of the substrate sheet, the substrate sheet being sandwiched between said skin sheets.

6. A method as claimed in claim 3, including:
co-extruding the substrate and the skin, fully covering an exterior of the substrate which forms a core within said skin.

7. A method as claimed in claim 1, wherein the thickness of the protective skin is in the range 0.01 mm to 1.0 mm.

8. A method as claimed in claim 7 wherein the thickness of the substrate is in the range 1 mm to 50 mm.

9. A method as claimed in claim 1 wherein the plastics material blend forming the skin has a glass content in the range 1.0% to 50% by weight.

10. A method as claimed in claim 1 wherein the plastics material blend forming the protective skin has a plastics content in the range 65% to 97%.

11. A method as claimed in claim 1 wherein the plastics material forming the substrate and the plastic material in the plastics material blend forming the protective skin are the same material.

12. A method as claimed in claim 11 wherein the plastics material is polyethylene terephthalate material.

13. A method as claimed in claim 11 wherein the plastics material is polycarbonate material.

14. A method as claimed in claim 11 wherein the plastics material is polypropylene material.

15. A method as claimed in claim 11 wherein the plastics material of the plastics material blend is selected from any one or more of the following plastics materials; acrylic, polyethylene, poly vinyl chloride, acrylonitrile butadiene styrene, polystyrene and any compounds and/or alloys of such plastics materials, as well as homo and co-polymer materials and alloys and compounds thereof.

16. A method as claimed in claim 1 wherein the plastics material forming the substrate and the plastics material in the plastics material blend forming the protective skin are different plastics material.

17. A method as claimed in claim 1 wherein the plastics material blend includes glass material in the form of strands.

18. A method as claimed in claim 17 wherein the plastics material blend includes glass material in strand form of diameter in the range 10 to 50 microns, and of 15 length in the range 100 microns to 1000 microns.

19. A method as claimed in claim 1 wherein the plastics material blend includes glass material in the form of fibres.

20. A method as claimed in claim 1 wherein the plastics material blend includes glass material in the form of beads.

21. A method as claimed in claim 1 wherein the plastics material blend includes glass material in powder form.

22. A method as claimed in claim 1 wherein the plastics material blend includes one or more additives selected from the following group: an impact modifier, a dispersing agent, an ultraviolet stabiliser, a flame retardant, a coloring agent.

23. A method for manufacturing a plastics material of a relatively good scratch resistance and relatively high temperature stability, said method including:
co-extruding a substrate sheet of plastics material and a protective skin sheet comprising a plastics material blend of plastics material and glass material,
overlaying the protective skin sheet and the substrate sheet, and bonding the protective skin sheet to the substrate sheet,
the thickness of the protective skin sheet being in the range 0.01 mm to 1.0 mm,
the thickness of the substrate sheet being in the range 1 mm to 50 mm,
the plastics material blend forming the protective skin sheet having a glass content in the range 1.0% to 50% by weight,
the plastics material blend forming the protective skin sheet having a plastics content in the range 65% to 97% by weight.

24. A method for manufacturing a plastics material of a relatively good scratch resistance and relatively high temperature stability, said method including:
co-extruding a substrate sheet of plastics material and a protective skin sheet comprising a plastics material blend of plastics material and glass material,
overlaying the protective skin sheet and the substrate sheet, and bonding the protective skin sheet to the substrate sheet,
the thickness of the protective skin sheet being in the range 0.01 mm to 1.0 mm,
the thickness of the substrate sheet being in the range 1 mm to 50 mm,
the plastics material blend forming the protective skin sheet having a glass content in the range 1.0% to 50% by weight,
the plastics material blend forming the protective skin sheet having a plastics content in the range 65% to 97% by weight,
the plastics material forming the substrate sheet and the plastics material in the plastics material blend forming the protective skin sheet being the same material and being selected from the group comprising: polyethylene terephthalate, polycarbonate, polypropylene, acrylic, polyethylene, poly vinyl chloride, acrylonitrile butadiene styrene, polystyrene, and any compounds and/or alloys of such plastics materials, as well as homo and co-polymer materials and alloys and compounds thereof.

25. A method for manufacturing a plastics material of a relatively good scratch resistance and relatively high temperature stability, said method including:
co-extruding a substrate sheet of plastics material and a protective skin sheet comprising a plastics material blend of plastics material and glass material,
overlaying the protective skin sheet and the substrate sheet, and bonding the protective skin sheet to the substrate sheet,
the thickness of the protective skin sheet being in the range 0.01 mm to 1.0 mm,
the thickness of the substrate sheet being in the range 1 mm to 50 mm,
the plastics material blend forming the protective skin sheet having a glass content in the range 1.0% to 50% by weight,
the plastics material blend forming the protective skin sheet having a plastics content in the range 65% to 97% by weight,
the plastics material forming the substrate sheet and the plastics material in the plastics material blend forming the protective skin sheet being the same material and being selected from the group comprising: polyethylene terephthalate, polycarbonate, polypropylene, acrylic, polyethylene, poly vinyl chloride, acrylonitrile butadiene styrene, polystyrene, and any compounds and/or alloys of such plastics materials, as well as homo and co-polymer materials and alloys and compounds thereof,
the plastics material blend including glass material in strand form of diameter in the range 10 to 50 microns and of length in the range 100 microns to 1000 microns.

26. A method for manufacturing a plastics material of a relatively good scratch resistance and relatively high temperature stability, said method including:
co-extruding a substrate sheet of plastics material and a protective skin sheet comprising a plastics material blend of plastics material and glass material, overlaying the protective skin sheet and the substrate sheet, and
bonding the protective skin sheet to the substrate sheet,
the thickness of the protective skin sheet being in the range 0.01 mm to 1.0 mm,
the thickness of the substrate sheet being in the range 1 mm to 50 mm,
the plastics material blend forming the protective skin sheet having a glass content in the range 1.0% to 50% by weight,
the plastics material blend forming the protective skin sheet having a plastics content in the range 65% to 97% by weight,
the plastics material forming the substrate sheet and the plastics material in the plastics material blend forming the protective skin sheet being the same material and being selected from the group comprising: polyethylene terephthalate, polycarbonate, polypropylene, acrylic, polyethylene, poly vinyl chloride, acrylonitrile butadiene styrene, polystyrene, and any compounds and/or alloys of such plastics materials, as well as homo and co-polymer materials and alloys and compounds thereof,
the plastics material blend including one or more additives selected from the group: an impact modifier, a dispersing agent, an ultraviolet stabiliser, a flame retardant, a coloring agent.

27. A method for manufacturing a plastics material of relatively good scratch resistance and relatively high temperature stability, said method including:
co-extruding a substrate sheet of plastics material and a pair of protective skin sheets each comprising a plastics material blend of plastics material and glass material, bonding the protective skin sheets to opposite sides of the substrate sheet, the substrate sheet being sandwiched between said protective skin sheets,
the thickness of each protective skin sheet being in the range 0.01 mm to 1.0 mm,
the thickness of the substrate sheet being in the range 1 mm to 50 mm,
the plastics material blend forming each protective skin sheet having a glass content in the range 1.0% to 50% by weight,
the plastics material blend forming each protective skin sheet having a plastics content in the range 65% to 97% by weight.

28. A method for manufacturing a plastics material of relatively good scratch resistance and relatively high temperature stability, said method including:
co-extruding a substrate sheet of plastics material and a pair of protective skin sheets each comprising a plastics material blend of plastics material and glass material, bonding the protective skin sheets to opposite sides of the substrate sheet, the substrate sheet being sandwiched between said protective skin sheets,
the thickness of each protective skin sheet being in the range 0.01 mm to 1.0 mm,
the thickness of the substrate sheet being in the range 1 mm to 50 mm,
the plastics material blend forming each protective skin sheet having a glass content in the range 1.0% to 50% by weight, the plastics material blend forming each protective skin sheet having a plastics content in the range 65% to 97% by weight,
the plastics material forming the substrate sheet and the plastics material in the plastics material blend forming the protective skin sheets being the same material and being selected from the group comprising: polyethylene terephthalate, polycarbonate, polypropylene, acrylic, polyethylene, poly vinyl chloride, acrylonitrile butadiene styrene, polystyrene, and any compounds and/or alloys of such plastics materials, as well as homo and co-polymer materials and alloys and compounds thereof.

29. A method for manufacturing a plastics material of relatively good scratch resistance and relatively high temperature stability, said method including:
co-extruding a substrate sheet of plastics material and a pair of protective skin sheets each comprising a plastics material blend of plastics material and glass material, bonding the protective skin sheets to opposite sides of the substrate sheet, the substrate sheet being sandwiched between said protective skin sheets,
the thickness of each protective skin sheet being in the range 0.01 mm to 1.0 mm,
the thickness of the substrate sheet being in the range 1 mm to 50 mm,
the plastics material blend forming each protective skin sheet having a glass content in the range 1.0% to 50% by weight,
the plastics material blend forming each protective skin sheet having a plastics content in the range 65% to 97% by weight,
the plastics material forming the substrate sheet and the plastics material in the plastics material blend forming the protective skin sheets being the same material and being selected from the group comprising:
polyethylene terephthalate, polycarbonate, polypropylene, acrylic, polyethylene, polyvinyl chloride, acrylonitrile butadiene styrene, polystyrene, and any compounds and/or alloys of such plastics materials, as well as homo and co-polymer materials and alloys and compounds thereof,
the plastics material blend including glass material in strand form of diameter in the range 10 to 50 microns and of length in the range 100 microns to 1000 microns.

30. A method for manufacturing a plastics material of relatively good scratch resistance and relatively high temperature stability, said method including:
co-extruding a substrate sheet of plastics material and a pair of protective skin sheets each comprising a plastics material blend of plastics material and glass material, bonding the protective skin sheets to opposite sides of the substrate sheet, the substrate sheet being sandwiched between said protective skin sheets,
the thickness of each protective skin sheet being in the range 0.01 mm 1.0 mm,
the thickness of the substrate sheet being in the range 1 mm to 50 mm, the plastics material blend forming each protective skin sheet having a glass content in the range 1.0% to 50% by weight,
the plastics material blend forming each protective skin sheet having a plastics content in the range 65% to 97% by weight,
the plastics material forming the substrate sheet and the plastics material in the plastics material blend forming the protective skin sheets
being the same material and being selected from the group comprising: polyethylene terephthalate, polycarbonate, polypropylene, acrylic, polyethylene, poly vinyl chloride, acrylonitrile butadiene styrene, polystyrene, and any compounds and/or alloys of such plastics materials, as well as homo and co-polymer materials and alloys and compounds thereof,
the plastics material blend including one or more additives selected from the group: an impact modifier, a dispersing agent, an ultraviolet stabiliser, a flame retardant, a coloring agent.

31. A method for manufacturing a plastics material of relatively good scratch resistance and relatively high temperature stability, said method including:
co-extruding a substrate of plastics material and a protective skin comprising a plastics material blend of plastics material and glass material, fully covering an exterior of the substrate with the protective skin such that the substrate forms a core within said protective skin,
the thickness of the protective skin being in the range 0.01 mm to 1.0 mm,
the thickness of the substrate being in the range 1 mm to 50 mm,
the plastics material blend forming the protective skin having a glass content in the range 1.0% to 50% by weight,
the plastics material blend forming the protective skin having a plastics content in the range 65% to 97% by weight.

32. A method for manufacturing a plastics material of relatively good scratch resistance and relatively high temperature stability, said method including:
forming an outer protective skin on a substrate of plastics material,
said protective skin comprising a plastics material blend of plastics material and glass material,
the thickness of the protective skin being in the range 0.01 mm to 1.0 mm,
the thickness of the substrate being in the range 1 mm to 50 mm,
the plastics material blend forming the protective skin having a glass content in the range 1.0% to 50% by weight,
the plastics material blend forming the protective skin having a plastics content in the range 65% to 97% by weight,
the plastics material forming the substrate sheet and the plastics material in the plastics material blend forming the protective skin being the same material and being selected from the group comprising: polyethylene terephthalate, polycarbonate, polypropylene, acrylic, polyethylene, poly vinyl chloride, acrylonitrile butadiene styrene, polystyrene, and any compounds and/or alloys of such plastics materials, as well as homo and co-polymer materials and alloys and compounds thereof,
the plastics material blend including one or more additives selected from the group: an impact modifier, a dispersing agent, an ultraviolet stabiliser, a flame retardant, a coloring agent.

33. A plastics material comprising a substrate of plastics material at least partially covered by an outer protective skin comprising a plastics material blend of plastics material and glass material.

34. A plastics material comprising a substrate of plastics material at least partially covered by an outer protective skin comprising a plastics material blend of plastics material and glass material,
the thickness of the protective skin being in the range 0.01 mm to 10 1.0 mm,
the thickness of the substrate being in the range 1 mm to 50 mm,
the plastics material blend forming the protective skin having a glass content in the range 1.0% to 50% by weight,
the plastics material blend forming the protective skin having a plastics content in the range 65% to 97% by weight.

35. A plastics material comprising a substrate of plastics material at least partially covered by an outer protective skin comprising a plastics material blend of plastics material and glass material,
the thickness of the protective skin being in the range 0.01 mm to 25 1.0 mm,
the thickness of the substrate being in the range 1 mm to 50 mm,
the plastics material blend forming the protective skin having a glass content in the range 1.0% to 50% by weight,
the plastics material blend forming the protective skin having a plastics content in the range 65% to 97% by weight,
the plastics material forming the substrate sheet and the plastics material in the plastics material blend forming the protective skin being the same material and being selected from the group comprising: polyethylene terephthalate, polycarbonate, polypropylene, acrylic, polyethylene, poly vinyl chloride, acrylonitrile butadiene styrene, polystyrene, and any compounds and/or alloys of such plastics materials, as well as homo and co-polymer materials and alloys and compounds thereof.

36. A plastics material comprising a substrate of plastics material at least partially covered by an outer protective skin comprising a plastics material blend of plastics material and glass material,
the thickness of the protective skin being in the range 0.01 mm to 1.0 mm,
the thickness of the substrate being in the range 1 mm to 50 mm,
the plastics material blend forming the protective skin having a glass content in the range 1.0% to 50% by weight,
the plastics material blend forming the protective skin having a plastics content in the range 65% to 97% by weight,
the plastics material forming the substrate sheet and the plastics material in the plastics material blend forming the protective skin being the same material and being selected from the group comprising: polyethylene terephthalate, polycarbonate, polypropylene, acrylic, polyethylene, poly vinyl chloride, acrylonitrile butadiene styrene, polystyrene, and any compounds and/or alloys of such plastics materials, as well as homo and co-polymer materials and alloys and compounds thereof, the plastics material blend including one or more additives selected from the group: an impact modifier, a dispersing agent, an ultraviolet stabiliser, a flame retardant, a coloring agent.

37. A plastics material sheet comprising a substrate sheet of plastics material covered on one side by an outer protective skin comprising a plastics material blend of plastics material and glass material, the thickness of the protective skin being in the range 0.01 mm to 1.0 mm, the thickness of the substrate being in the range 1 mm to 50 mm, the plastics material blend forming the protective skin having a glass content in the range 1.0% to 50% by weight, the plastics material blend forming the protective skin having a plastics content in the range 65% to 97% by weight.

38. A plastics material sheet comprising a substrate of plastics material covered on opposite sides by outer protective skins each of which comprises a plastics 20 material blend of plastics material and glass material,
the thickness of each protective skin being in the range 0.01 mm to 11.0 mm,
the thickness of the substrate being in the range 1 mm to 50 mm,
the plastics material blend forming the protective skin having a glass content in the range 1.0% to 50% by weight,
the plastics material blend forming the protective skin having a plastics content in the range 65% to 97% by weight.

39. A plastics material sheet comprising a substrate of plastics material encased within an outer protective skin comprising a plastics material blend of plastics material and glass material,
the thickness of the protective skin being in the range 0.01 mm to 1.0 mm,
the thickness of the substrate being in the range 1 mm to 50 mm,
the plastics material blend forming the protective skin having a glass content in the range 1.0% to 50% by weight,
the plastics material blend forming the protective skin sheet having a plastics content in the range 65% to 97% by weight.

40. A plastics article whenever manufactured from a plastics material of the type claimed in claim 33.
